(19) United States
(12) Patent Application Publication
(10) Pub. No.: US 2010/0270476 A1
(43) Pub. Date: Oct. 28, 2010

(54) REACTION FORCE TREATMENT MECHANISM, XY STAGE APPARATUS, INSPECTION APPARATUS

(75) Inventors: Jun NISHIMAKI, Yokosuka-shi (JP); Yasuhito NAKAMORI, Yokosuka-shi (JP); Yoshiyuki TOMITA, Hiratsuka-shi (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: SUMITOMO HEAVY INDUSTRIES, LTD., Tokyo (JP)

(21) Appl. No.: 12/769,441

(22) Filed: Apr. 28, 2010

(30) Foreign Application Priority Data
Apr. 28, 2009 (JP) 2009-110013

(51) Int. Cl. G21K 5/10

(52) U.S. Cl. 250/442.11

(57) ABSTRACT

The invention can provide a reaction force treatment mechanism used in a stage apparatus including a pedestal, a platen which supported by the pedestal through a vibration isolation unit, a mobile body which supported by the platen and moves on the platen, and an actuator which actuates the mobile body in one direction, the reaction force treatment mechanism including: a connection portion which connects a stator of the actuator to the pedestal through an stress relief mechanism for absorbing displacement in a direction different from the one direction; and a guide portion which movably guides the stator of the actuator in the one direction while restraining the stator of the actuator relative to the platen in a direction different from the one direction.

### RELATED APPLICATION

Priority is claimed on Japanese Patent Application No. 2009-110013, filed on Apr. 28, 2009, the content of which is incorporated herein by reference.

### BACKGROUND OF THE INVENTION

1. Technical Field

The present invention relates to a reaction force treatment mechanism used in a stage apparatus, and an inspection apparatus including the same.

2. Description of the Related Art

As existing reaction force treatment mechanisms, there is known a reaction force treatment mechanism which is used in a stage apparatus including a platen supported through a vibration isolation unit, a mobile body supported on the platen and moving on the platen, and an actuator actuating the mobile body in one direction. In such a reaction force treatment mechanism, a stator of the actuator is connected to a floor by a support member, and a reaction force applied to the stator upon driving the actuator is transferred to the floor, thereby suppressing vibration of the platen.

However, in the reaction force treatment mechanism, as described above, since the stator of the actuator is connected to the floor, the footprint of the stage apparatus increases, which may cause a concern in that the stage apparatus increases in size.

In addition, in the above-described reaction force treatment mechanism, for example, in the case of using a linear motor as an actuator, the stator is provided separately from the platen, and the mobile body supported by the platen is provided with a mover of the actuator. For this reason, when relative displacement is generated between the platen and the stator due to an influence such as an external force, relative displacement is generated between the mover and the stator, and hence the mover and the stator may come into contact with each other.

### SUMMARY OF THE INVENTION

Therefore, the invention provides a reaction force treatment mechanism capable of suppressing vibration of a platen and decreasing size of a stage apparatus.

The invention provides a reaction force treatment mechanism used in a stage apparatus including a pedestal, a platen which is supported by the pedestal through a vibration isolation unit, a mobile body which is supported by the platen and moves on the platen, and an actuator which actuates the mobile body in one direction, the reaction force treatment mechanism including: a connection portion which connects a stator of the actuator to the pedestal through a stress relief mechanism for absorbing displacement in a direction different from the one direction; and a guide portion which movably guides the stator of the actuator in the one direction while restricting the movement of the stator of the actuator relative to the platen in a direction different from the one direction.

### BRIEF DESCRIPTION OF THE DRAWINGS

FIG. 1 is a perspective view showing a stage apparatus which uses a reaction force treatment mechanism according to an embodiment of the invention.

FIG. 2 is a schematic plan view showing the stage apparatus of FIG. 1.

FIG. 3 is a side view showing the stage apparatus of FIG. 1.

FIG. 4 is a sectional view taken along the line IV-IV of FIG. 2.

FIG. 5 is a perspective view showing an X-axis reaction force treatment mechanism according to the embodiment.

FIG. 6 is a perspective view showing an X-axis stress relief mechanism of the X-axis reaction force treatment mechanism of FIG. 5.

FIG. 7 is a perspective view showing a Y-axis reaction force treatment mechanism according to the embodiment.

### DETAILED DESCRIPTION OF THE INVENTION

Hereinafter, a preferred embodiment of the invention will be described in detail with reference to the accompanying drawings. In addition, in the description below, the same reference numerals are given to the same or corresponding constituents, and the repetitive description thereof is omitted.

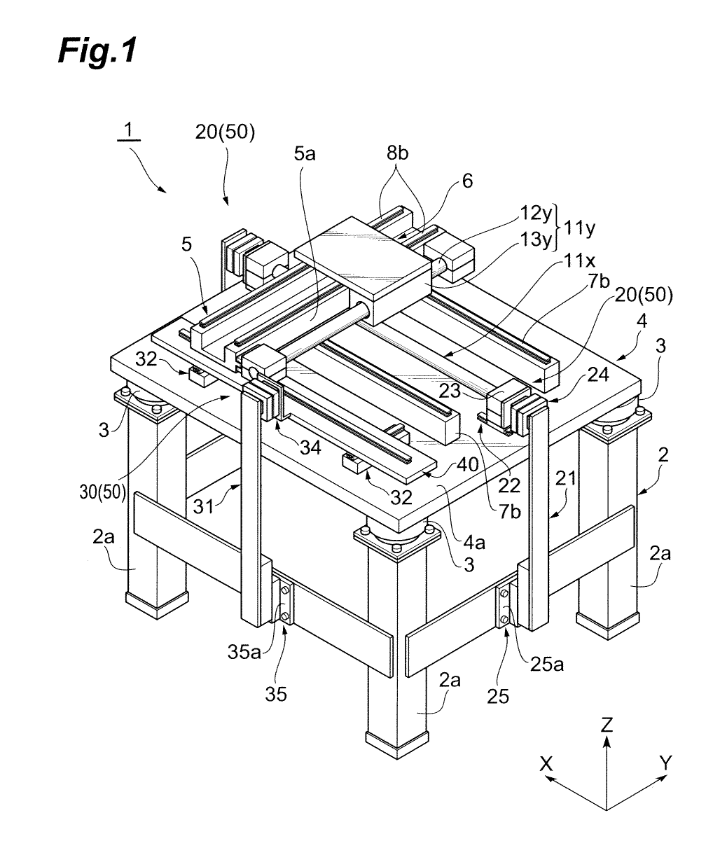

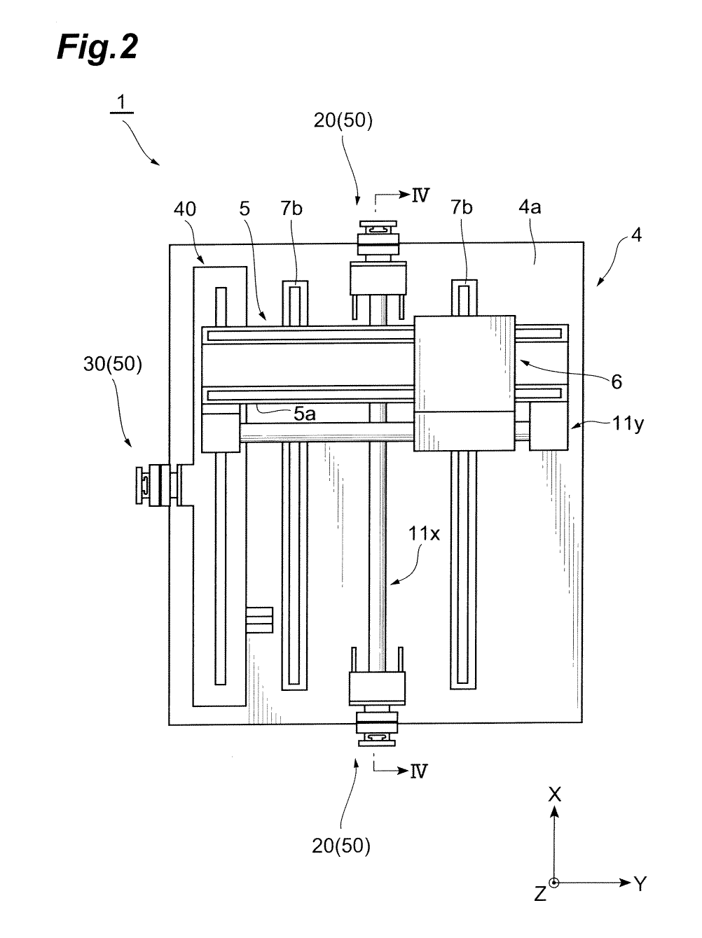

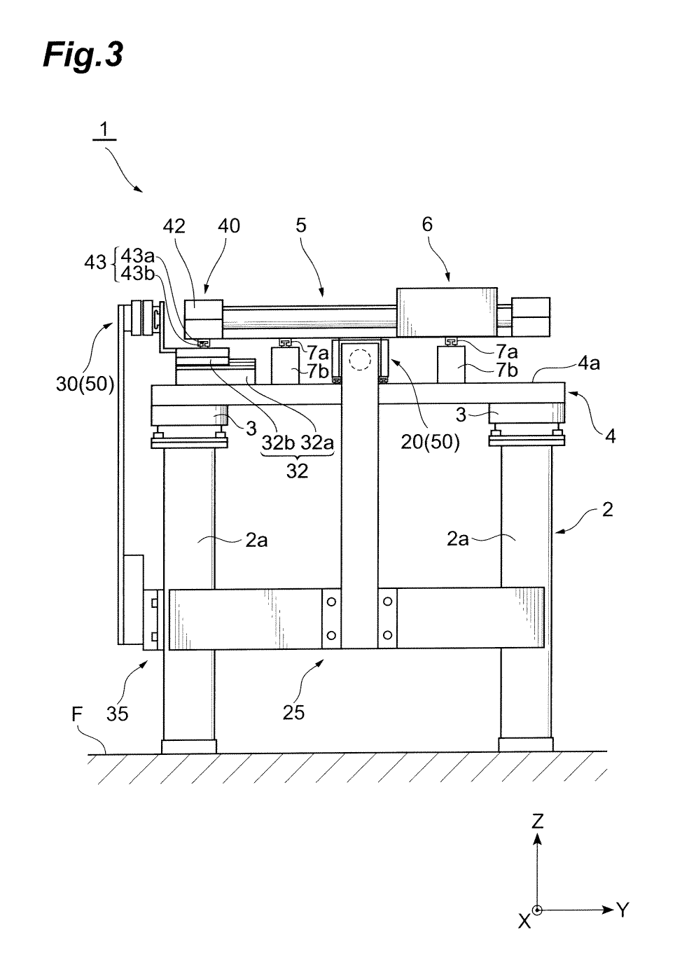

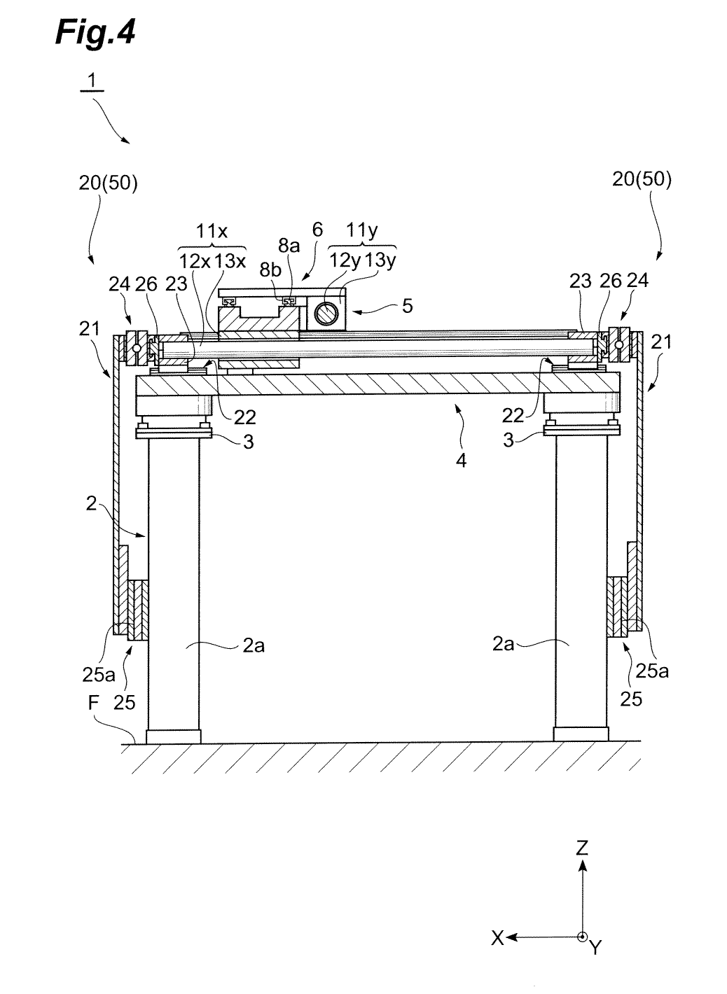

FIG. 1 is a perspective view showing a stage apparatus which uses a reaction force treatment mechanism according to an embodiment of the invention. FIG. 2 is a schematic plan view showing the stage apparatus of FIG. 1. FIG. 3 is a side view showing the stage apparatus of FIG. 1. FIG. 4 is a sectional view taken along the line IV-IV of FIG. 2.

As shown in FIGS. 1 to 4, a stage apparatus 1 is, for example, an XY stage apparatus which is assembled in a semiconductor examination/exposure apparatus for performing the examination/exposure of semiconductors, and is disposed to face an optical system frame (not shown) such as a microscope or a camera so as to be used for the position adjustment of semiconductor wafers.

As shown in FIG. 1, the stage apparatus 1 is a so-called stack-type stage apparatus which includes a pedestal 2, a platen 4 which is supported by the pedestal 2 through a vibration isolation unit 3, and X-axis and Y-axis mobile bodies (first and second mobile bodies) 5 and 6 moving on the platen 4, where the Y-axis mobile body 6 moves on the X-axis mobile body 5 while being supported thereon.

The pedestal 2 is a lower structure as a base of the stage apparatus 1, and includes, for example, four leg portions 2a which stand on a floor F (refer to FIG. 3) or the like of a factory.

The vibration isolation unit 3 dampens and removes vibration transferred between the pedestal 2 and the platen 4, and includes, for example, an elastic member such as an air spring or rubber. The vibration isolation unit 3 is fixed to the upper end of the leg portion 2a of the pedestal 2.

The pedestal 4 is formed by, for example, stone material so as to have an elongated rectangular shape, and is fixed to the upper end of the vibration isolation unit 3. Since a board base 4a of the platen 4 is subjected to a surface machining operation, the flatness thereof is increased.

The X-axis mobile body 5 is adapted to move on the platen 4 along the X-axis direction (first direction) as the lower-axis direction which is one direction in the horizontal direction. As shown in FIG. 3, the X-axis mobile body 5 is formed as an elongated plate shape, and includes a pair of X-axis sliders 7a and 7a provided on the lower surface thereof. The X-axis sliders 7a and 7a engage with a pair of X-axis guide rails 7b and 7b which are provided on the platen 4 and extend in the X-axis direction. Accordingly, the X-axis mobile body 5 is supported on the platen 4a in the Z-axis direction as the vertical direction, and is adapted to be slidable along the X-axis guide rail 7b, that is, movable along the X-axis direction.

As shown in FIG. 4, the Y-axis mobile body 6 moves on the X-axis mobile body 5 along the Y-axis direction (second direction) as the upper-axis direction which is a direction perpendicular to the X-axis direction in the horizontal direction. The Y-axis mobile body 6 is formed as a rectangular plate shape, and includes a pair of Y-axis sliders 8a and 8a provided on the lower surface thereof The Y-axis sliders 8a and 8a engage with a pair of Y-axis guide rails 8b and 8b which are provided on the X-axis mobile body 5 and extend in the Y-axis direction. Accordingly, the Y-axis mobile body 6 is supported on the X-axis mobile body 5 in the Z-axis direction, and is adapted to be slidable along the Y-axis guide rail 8b, that is, movable along the Y-axis direction.

In addition, as shown in FIG. 1, the stage apparatus 1 includes an X-axis shaft motor (first actuator) 11x and a Y-axis shaft motor (second actuator) 11y.

As shown in FIG. 4, the X-axis shaft motor 11x is an actuator which drives the X-axis mobile body in the X-axis direction, and includes an X-axis shaft portion 12x as a stator and an X-axis coil portion 13x as a mover.

The X-axis shaft portion 12x includes a magnet therein, and extends along the X-axis direction at the center position on the platen 4. Both ends of the X-axis shaft portion 12x are fixed to an X-axis fixed block portion 23 of which the movement in the X-axis direction is guided by an X-axis linear guide (a first guide portion and a stator support portion) 22, and are connected to the pedestal 2 by an X-axis reaction frame (first connection portion) 21 through an X-axis stress relief mechanism (first stress relief mechanism) 24 (the detail thereof will be described later).

The X-axis coil portion 13x is movable along the X-axis shaft portion 12x, and includes therein a coil which surrounds the X-axis shaft portion 12x. The X-axis coil portion 13x is inserted to the outside of the X-axis shaft portion 12x with a predetermined gap therebetween, and is fixed to the lower surface of the X-axis mobile body 5.

Accordingly, in the X-axis shaft motor 11x, when a predetermined current is applied to the X-axis coil portion 13x, the X-axis coil portion 13x is moved in the X-axis direction by electromagnetic interaction, thereby driving the X-axis mobile body 5 in the X-axis direction.

The Y-axis shaft motor 11y is an actuator which drives the Y-axis mobile body 6 in the Y-axis direction, and includes a Y-axis shaft portion 12y as a stator and a Y-axis coil portion 13y as a mover as in the X-axis shaft motor 11x.

As shown in FIG. 1, the Y-axis shaft portion 12y includes a magnet therein, and extends along the Y-axis direction from one side of the X-axis mobile body 5 in the X-axis direction. One end (the left end in the drawing) of the Y-axis shaft portion 12y is supported by a Y-axis shaft portion support mechanism (support mechanism) 40 of which the movement in the Y-axis direction is guided by a Y-axis linear guide (a second guide and a stator support portion) 32, and is connected to the pedestal 2 by a Y-axis reaction frame (second connection portion) 31 through a Y-axis stress relief mechanism (second stress relief mechanism) 34 (the detail thereof will be described later). In addition, the other end (the right end in the drawing) of the Y-axis shaft portion 12y is fixed to the X-axis mobile body 5.

The Y-axis coil portion 13y is movable along the Y-axis shaft portion 12y, and includes therein a coil which surrounds the Y-axis shaft portion 12y. The Y-axis coil portion 13y is inserted to the outside of the Y-axis shaft portion 12y with a predetermined gap therebetween, and is fixed to the lower surface of one side of the Y-axis mobile body 6 in the X-axis direction.

Accordingly, in the Y-axis shaft motor 11y, when a predetermined current is applied to the Y-axis coil portion 13y, the Y-axis coil portion 13y is moved in the Y-axis direction by electromagnetic interaction, thereby driving the Y-axis mobile body 6 in the Y-axis direction.

In addition, the stage apparatus 1 includes a linear scale (not shown) which detects each of the positions of the mobile bodies 5 and 6 by using, for example, a laser beam.

Here, as described above, a reaction force treatment mechanism 50 is used in the stage apparatus 1. The reaction force treatment mechanism 50 includes an X-axis reaction force treatment mechanism 20 which treats a reaction force (hereinafter, referred to “X-axis reaction force”) applied to the X-axis shaft portion 12x upon driving the X-axis shaft motor 11x. In addition, specifically, the X-axis reaction force mentioned herein is a force which is obtained as a reaction against thrust applied from the X-axis shaft motor 11x to the X-axis mobile body 5, where the X-axis direction is a direction of the force.

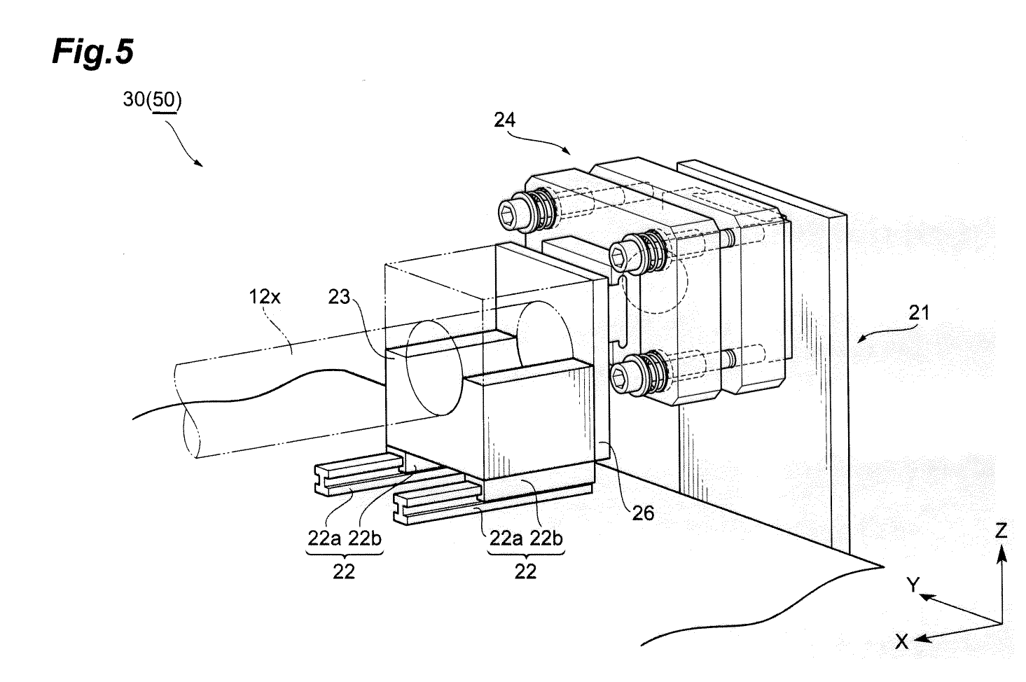

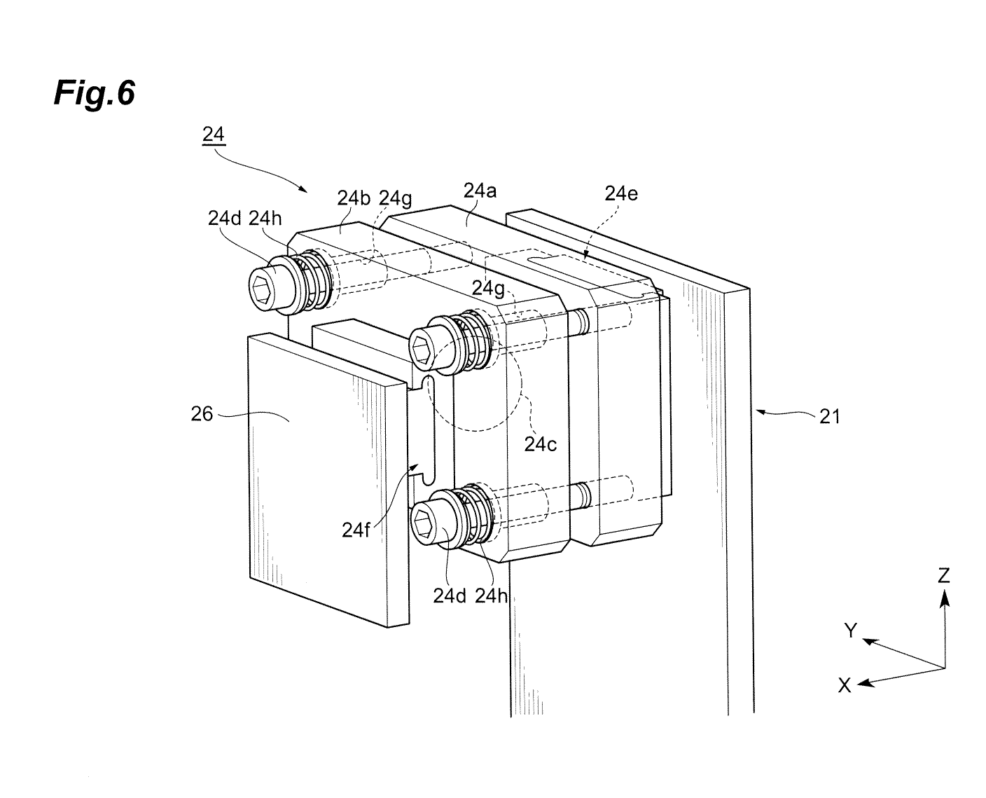

FIG. 5 is a perspective view showing an X-axis reaction force treatment mechanism according to the embodiment. FIG. 6 is a perspective view showing an X-axis stress relief mechanism of the X-axis reaction force treatment mechanism of FIG. 5. As shown in FIG. 5, the X-axis reaction force treatment mechanism 20 is attached to both ends of the X-axis shaft portion 12x, and includes an X-axis reaction frame 21 and an X-axis linear guide 22.

As shown in FIG. 4, the X-axis reaction frame 21 is adapted to transfer the X-axis reaction force applied to the X-axis shaft portion 12x to the pedestal 2. The X-axis reaction frame 21 is formed as a plate shape extending in the Z-axis direction, and connects and fixes the end of the X-axis shaft portion 12x to the pedestal 2. Herein, in the reaction force treatment mechanisms 20 and 20 which are attached to both ends of the X-axis shaft portion 12x, the X-axis reaction frames 21 and 21 are adapted to sandwich both ends of the X-axis shaft portion 12x, and the X-axis reaction frames 21 and 21 connect both ends of the X-axis shaft portion 12x to the pedestal 2 so as to restrict the degree of freedom in the X-axis direction.

In detail, the lower end of the X-axis reaction frame 21 is fixed to the pedestal 2 through a reaction force receiving member 25 which is provided so as to cross over the leg portion 2a of the pedestal 2. The reaction force receiving member 25 includes a reaction force receiving surface 25a which has the normal direction corresponding to the X-axis direction so as to desirably receive the transferred reaction force (refer to FIG. 1).

Also, the upper end of the X-axis reaction frame 21 is fixed to a stay 26, which is fixed to the X-axis fixed block portion 23, through the X-axis stress relief mechanism 24. The X-axis stress relief mechanism 24 is adapted to absorb displacement in a direction different from the X-axis direction. Herein, the X-axis stress relief mechanism 24 has five degrees of freedom other than the X-axis direction, and absorbs the displacement in directions other than the X-axis direction (that is, absorbs the relative position displacement between the platen 4 and the pedestal 2). In more detail, the X-axis stress relief mechanism 24 has the following configuration.

That is, as shown in FIG. 6, in the X-axis stress relief mechanism 24, a pair of block portions 24a and 24b is disposed in parallel in the X-axis direction with a ball 24c interposed therebetween, and the block portions 24a and 24b can be pressed against each other by bolts 24d, so that the block portions 24a and 24b are relatively rotatable in the rotation directions θx, θy, and θz of the rotation in the X-axis, Y-axis, and Z-axis directions about the ball 24c. Accordingly, the displacement in the rotation directions θx, θy, and θz is absorbed.

In addition, a Z-axis guide portion 24e is provided between the block portion 24a and the X-axis reaction frame 21, and the block portion 24a is fixed to the X-axis reaction frame 21 so as to be relatively movable in the Z-axis direction. Accordingly, the displacement in the Z-axis direction is absorbed. Further, a Y-axis guide portion 24f is provided between the block portion 24b and the stay 26, and the block portion 24b is fixed to the stay 26 so as to be relatively movable in the Y-axis direction. Accordingly, the displacement in the Y-axis direction is absorbed.

Further, in the X-axis stress relief mechanism 24, the diameter of a perforation hole 24g for allowing the bolt 24d to be inserted into the block portion 24b therethrough is set to be larger than the diameter of the bolt 24d, thereby preventing the deterioration of the relative rotation between the block portions 24a and 24b. In addition, the block portion 24b is urged toward the block portion 24a by a spring 24h, thereby preventing the separation of the ball 24c during the relative rotation of the block portions 24a and 24b.

As shown in FIG. 5, the X-axis linear guide 22 guides the movement of the X-axis shaft portion 12x relative to the platen 4 in the X-axis direction while restricting the movement in a direction different from the X-axis direction. The X-axis linear guide 22 includes a pair of X-axis guide rails 22a and 22a which is fixed to the platen 4 and extends along the X-axis direction, and a pair of X-axis sliders 22b and 22b which is fixed to the X-axis fixed block portion 23 and engages with the X-axis guide rails 22a and 22a in the Y-axis and Z-axis directions.

Accordingly, the X-axis linear guide 22 serves as a linear guide mechanism which moves the X-axis fixed block portion 23 only in the X-axis direction, and regulates the movement of the X-axis fixed block portion 23 in a direction (that is, the Y-axis and Z-axis directions) other than the X-axis direction. In other words, the X-axis linear guide 22 restricts the degree of freedom of the X-axis shaft portion 12x in directions other than the X-axis direction.

Returning to FIG. 1, the reaction force treatment mechanism 50 of the embodiment further includes a Y-axis reaction force treatment mechanism 30 which treats a reaction force (hereinafter, referred to as “Y-axis reaction force”) applied to the Y-axis shaft portion 12y upon driving the Y-axis shaft motor 11y. In addition, specifically, the Y-axis reaction force mentioned herein is a force which is obtained as a reaction against thrust applied from the Y-axis shaft motor 11y to the Y-axis mobile body 6, where the Y-axis direction is a direction of the force.

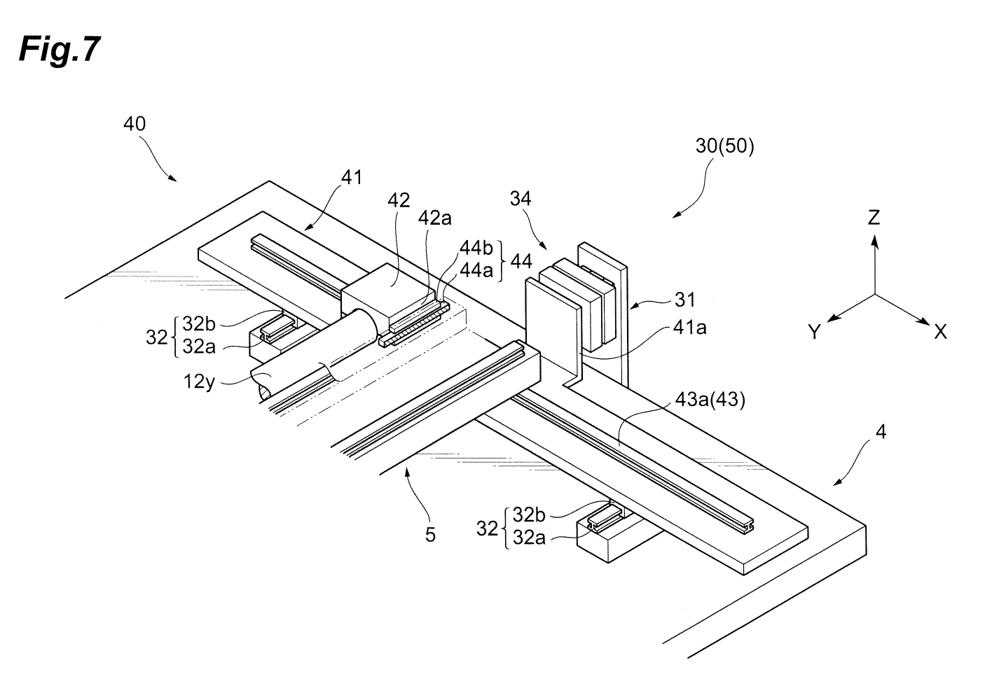

FIG. 7 is a perspective view showing a Y-axis reaction force treatment mechanism according to the embodiment. As shown in FIG. 7, the Y-axis reaction force treatment mechanism 30 includes a Y-axis reaction frame 31 and a Y-axis linear guide 32, and also includes a Y-axis shaft portion support mechanism 40 which supports the Y-axis shaft portion 12y.

The Y-axis reaction frame 31 is adapted to transfer the Y-axis reaction force applied to the Y-axis shaft portion 12y to the pedestal 2. As shown in FIG. 1, the Y-axis reaction frame 31 is formed as a plate shape which extends in the Z-axis direction, and connects and fixes one end of the Y-axis shaft portion 12y to the pedestal 2. Herein, the Y-axis reaction frame 31 connects the Y-axis shaft portion support mechanism 40 to the pedestal 2 so as to restrict the degree of freedom in the Y-axis direction.

In detail, the lower end of the Y-axis reaction frame 31 is fixed to the pedestal 2 through a reaction force receiving member 35 which is provided so as to cross over the leg portion 2a of the pedestal 2. The reaction force receiving member 35 includes a reaction force receiving surface 35a which has the normal direction corresponding to the Y-axis direction so as to desirably receive the transferred Y reaction force.

Also, as shown in FIG. 7, the upper end of the Y-axis reaction frame 31 is fixed to the Y-axis shaft portion support mechanism 40 through the Y-axis stress relief mechanism 34. The Y-axis stress relief mechanism 34 is adapted to absorb displacement in a direction different from the Y-axis direction. Herein, the Y-axis stress relief mechanism 34 has the same configuration as that of the X-axis stress relief mechanism 24, and absorbs the displacement in directions other than the Y-axis direction. That is, the Y-axis stress relief mechanism has five degrees of freedom other than the Y-axis direction.

The Y-axis linear guide 32 guides the movement of the Y-axis shaft portion 12y relative to the platen 4 in the Y-axis direction while restricting the movement in a direction different from the Y-axis direction. The Y-axis linear guide 32 includes a pair of Y-axis guide rails 32a and 32a which is fixed to the platen 4 and extends along the Y-axis direction, and a pair of Y-axis sliders 32b and 32b which is fixed to the Y-axis shaft portion support mechanism 40 and engages with the Y-axis guide rails 32a and 32a in the X-axis and Z-axis directions.

Accordingly, the Y-axis linear guide 32 serves as a linear guide mechanism which moves the Y-axis shaft portion support mechanism 40 only in the Y-axis direction, and regulates the movement of the Y-axis shaft portion support mechanism 40 in directions (that is, the X-axis and Z-axis directions) other than the Y-axis direction. In other words, the Y-axis linear guide 32 restricts the degree of freedom of the Y-axis shaft portion 12y in directions other than the Y-axis direction.

The Y-axis shaft portion support mechanism 40 supports the Y-axis shaft portion 12y while permitting the synchronization movement in the X-axis direction between the Y-axis shaft portion 12y and the X-axis mobile body 5 and permitting the relative movement thereof in the Y-axis direction so as to prevent the Y-axis reaction force from being transferred from the Y-axis shaft portion 12y to the X-axis mobile body 5. The Y-axis shaft portion support mechanism 40 includes a support base (base portion) 41, a Y-axis fixed block portion (fixed block) 42, an X-axis linear guide (first support mechanism guide portion) 43, and a Y-axis linear guide (second support mechanism guide portion) 44.

The support base 41 is formed as a plate shape, and is disposed on the end on the platen 4 in the Y-axis direction. The lower surface of the support base 41 is provided with the Y-axis slider 32b of the Y-axis linear guide 32. In addition, the Y-axis reaction frame 31 is fixed to a stay 41a of the support base 41 through the Y-axis stress relief mechanism 34. The Y-axis fixed block portion 42 is disposed on the support base 41, and is fixed to the Y-axis shaft portion 12y.

The X-axis linear guide 43 is provided between the support base 41 and the Y-axis fixed block portion 42, and guides the movement of the Y-axis fixed block portion 42 relative to the support base 41 in the X-axis direction while restricting the movement in the Y-axis direction. In detail, the X-axis linear guide 43 includes a pair of X-axis guide rails 43a and 43a which is provided in the support base 41 and extends in the X-axis direction, and a pair of X-axis sliders 43b and 43b (refer to FIG. 3) which is provided in the Y-axis fixed block portion 42 and engages with the X-axis guide rails 43a and 43a in the Y-axis and Z-axis directions.

The Y-axis linear guide 44 is provided so as to connect the X-axis mobile body 5 to the Y-axis fixed block portion 42, and guides the movement of the Y-axis fixed block portion 42 relative to the X-axis mobile body 5 in the Y-axis direction while restricting the movement in the X-axis direction. In detail, the Y-axis linear guide 44 includes a Y-axis guide rail 44a which is provided in a side surface 5a (refer to FIG. 1) of the X-axis mobile body 5 and extends in the Y-axis direction, and a Y-axis slider 44b which is fixed to a side surface 42a of the Y-axis fixed block portion 42 and engages with the Y-axis guide rail 44a in the X-axis and Z-axis directions.

In the stage apparatus 1 having the above-described configuration, when thrust is applied to the X-axis mobile body 5 by the X-axis shaft motor 11x in the state where the X-axis fixed block portion 23 is guided by the X-axis linear guide 22, the X-axis mobile body 5 is moved on the platen 4 in the X-axis direction, and also the X-axis reaction force with respect to the X-axis shaft portion 12x is generated.

At this time, as described above, the X-axis shaft portion 12x is connected to the pedestal 2 by the X-axis reaction frame 21, and also the X-axis fixed block portion 23 fixed to the X-axis shaft portion 12x is movable relative to the platen 4 in the X-axis direction by the X-axis linear guide 22, so that a force in the X-axis direction stress reliefs (mechanically separates) between the platen 4 and the X-axis shaft portion 12x. For this reason, the X-axis reaction force of the X-axis shaft portion 12x is transferred in an order of the X-axis fixed block portion 23, the X-axis stress relief mechanism 24, the X-axis reaction frame 21, and the reaction force receiving member 25 without being transferred to the platen 4, and is transferred and treated in the pedestal 2.

As a result, since it is possible to suppress vibration of the platen 4 (improve the vibration isolation property) due to the X-axis reaction, and for example, it is not necessary to connect the X-axis shaft portion 12x to the floor or to additionally provide a reaction force treatment motor, it is possible to decrease the footprint of the stage apparatus 1 with a simple configuration.

Here, in the X-axis linear guide 22 of the embodiment, as described above, since the X-axis guide rail 22a and the X-axis slider 22b engage with each other in the Y-axis and Z-axis directions, the movement of the X-axis fixed block portion 23 relative to the platen 4 is regulated in the Y-axis and Z-axis directions, and the positional relationship between the platen 4 and the X-axis shaft portion 12x is maintained. Accordingly, since the occurrence of the relative displacement between the X-axis shaft portion 12x and the X-axis mobile body 5 supported by the platen 4 is suppressed, the occurrence of the relative displacement between the X-axis shaft portion 12x and the X-axis coil portion 13x fixed to the X-axis mobile body 5 is suppressed.

Further, as described above, the X-axis stress relief mechanism 24 is interposed between the X-axis fixed block portion 23 and the X-axis reaction frame 21, so that displacement in directions other than the X-axis direction is absorbed by the X-axis stress relief mechanism 24. In detail, in the X-axis stress relief mechanism 24, when the X-axis shaft portion 12x and the pedestal 2 are relatively displaced in the Y-axis and Z-axis directions, the relative displacement applied to the Y-axis and Z-axis guide portions 24f and 24e is absorbed. When the X-axis shaft portion 12x and the pedestal 2 are rotatably displaced, the rotation displacement generated by the rotation of the block portions 24a and 24b about the ball 24c is absorbed. When the X-axis shaft portion 12x and the pedestal 2 are relatively displaced in the X-axis direction, a force in which the X-axis shaft portion 12x is displaced, is transferred to the pedestal 2. Accordingly, for example, the deviation (displacement) of the X-axis shaft portion 12x in directions other than the X-axis direction due to an external force applied to the pedestal 2 is suppressed, and hence the occurrence of the relative displacement between the X-axis shaft portion 12x and the X-axis coil portion 13x is further suppressed. In addition, as deviation in the relative position of the platen 4 and the pedestal 2 is permitted, stress is hardly concentrated on the X-axis reaction frame 21.

Accordingly, it possible to suppress contact between the X-axis shaft portion 12x and the X-axis coil portion 13x while preventing a gap between the X-axis shaft portion and the X-axis coil portion from increasing due to an increase in the size of the X-axis shaft portion 11x.

In addition, in the case where the relative movement is regulated by the X-axis linear guide 22 in order to maintain the positional relationship between the platen 4 and the X-axis shaft portion 12x, even when the platen 4 is displaced relative to the pedestal 2 in directions other than the reaction force treatment direction, in the embodiment, since the X-axis shaft portion 12x is connected to the pedestal 2 by the X-axis stress relief mechanism 24 while having five degrees of freedom, it is possible to suppress stress from being applied to the X-axis reaction frame 21 by permitting displacement, and to transfer the X-axis reaction force to the pedestal 2.

Further, since the Y-axis fixed block portion 42 is adapted to be movable relative to the support base 41 in the X-axis direction by the X-axis linear guide 43, and also engages with the X-axis mobile body 5 in the X-axis direction by the Y-axis linear guide 44 (so as to regulate the relative movement), it is possible to appropriately move the Y-axis shaft portion 12y in synchronization with the X-axis mobile body 5, and thus to prevent the movement of the X-axis mobile body 5 from being hindered.

Also, in the stage apparatus 1 of the embodiment, when thrust is applied to the Y-axis mobile body 6 by the Y-axis shaft motor 11y, the Y-axis mobile body 6 is moved on the X-axis mobile body 5 in the Y-axis direction, and also the Y-axis reaction force is generated in the Y-axis shaft portion 12y.

At this time, as described above, since the Y-axis shaft portion support mechanism 40 supporting the Y-axis shaft portion 12y is connected to the pedestal 2 by the Y-axis reaction frame 31, and also the Y-axis shaft portion support mechanism 40 is adapted to be movable relative to the platen 4 in the Y-axis direction by the Y-axis linear guide 2, a force in the Y-axis direction stress reliefs between the platen 4 and the Y-axis shaft portion support mechanism 40. Accordingly, the Y-axis reaction force of the Y-axis shaft portion 12y is transferred in an order of the Y-axis fixed block portion 42, the X-axis linear guide 43, the support base 41, the Y-axis reaction frame 31, and the reaction force receiving member 35 without being transferred to the platen 4, and is transferred and treated in the pedestal 2.

As a result, since it is possible to suppress vibration of the platen 4 due to the Y-axis reaction force, and for example, it is not necessary to connect the Y-axis shaft portion 12y to the floor or to additionally provide a reaction force treatment motor, it is possible to decrease the footprint of the stage apparatus 1 with a simple configuration.

Here, in the Y-axis linear guide 32 of the embodiment, as described above, since the Y-axis guide rail 32a and the Y-axis slider 32b engage with each other in the X-axis and Z-axis directions, the movement of the Y-axis shaft portion support mechanism 40 relative to the platen 4 is regulated in the X-axis and Z-axis directions, and the positional relationship between the platen 4 and the Y-axis shaft portion 12y is maintained. Accordingly, since the occurrence of the relative displacement between the Y-axis shaft portion 12y and the Y-axis mobile body 6 supported by the platen 4 through the X-axis mobile body 5 is suppressed, the occurrence of the relative displacement between the Y-axis shaft portion 12y and the Y-axis coil portion 13y fixed to the Y-axis mobile body 6 is suppressed.

Further, as described above, the Y-axis stress relief mechanism 34 is interposed between the Y-axis shaft portion support mechanism 40 and the Y-axis reaction frame 31, and displacement in directions other than the Y-axis direction is absorbed by the Y-axis stress relief mechanism 34. For this reason, for example, the deviation of the Y-axis shaft portion 12y in directions other than the Y-axis direction is suppressed by an external force applied to the pedestal 2, and hence the occurrence of the relative displacement between the Y-axis shaft portion 12y and the Y-axis coil portion 13y is further suppressed. In addition, as deviation in the relative position of the platen 4 and the pedestal 2 is permitted, stress is hardly concentrated on the Y-axis reaction frame 31.

Accordingly, it is possible to suppress contact between the Y-axis shaft portion 12y and the Y-axis coil portion 13y while preventing a gap between the Y-axis shaft portion and the Y-axis coil portion from increasing due to an increase in the size of the Y-axis shaft motor 11y.

In addition, in the case where the relative movement is regulated by the Y-axis linear guide 32 in order to maintain the positional relationship between the platen 4 and the shaft portion 12y, even when relative displacement is generated between the platen 4 and the pedestal 2 in directions other than the reaction force treatment direction, in the embodiment, since the Y-axis shaft portion 12y is connected to the pedestal 2 while having five degrees of freedom, it is possible to suppress stress from being applied to the Y-axis reaction frame 31 by permitting displacement, and to transfer the Y-axis reaction force to the pedestal 2.

Further, since the Y-axis fixed block portion 42 is adapted to be movable relative to the X-axis mobile body 5 in the Y-axis direction by the Y-axis linear guide 44, a force in the Y-axis direction stress reliefs between the Y-axis fixed block portion 42 and the mobile body 5. For this reason, it is possible to suppress the Y-axis reaction force of the Y-axis shaft portion 12y from being transferred to the X-axis mobile body 5.

As described above, according to the reaction force treatment mechanism 50 of the embodiment, it is possible to suppress the vibration of the platen 4 due to the X-axis reaction force and the Y-axis reaction force, and to decrease the size of the stage apparatus 1. As a result, it is possible to improve the position detection precision of the mobile bodies 5 and 6 using the linear scale, and further to improve the position precision of the mobile bodies 5 and 6.

In addition, in the embodiment, as described above, the shaft motors 11x and 11y are used as the actuator. In the case of using the shaft motors 11x and 11y, since the gap formed between the shaft portions 12x and 12y and the coil portions 13x and 13y is small (narrow), the above-described advantage of suppressing the contact therebetween becomes remarkable.

Further, in the embodiment, as described above, since stress in directions other than the X-axis and Y-axis directions stress reliefs in the stress relief mechanisms 24 and 34, it is possible to prevent large load from being applied to the reaction frames 21 and 31. Accordingly, it is possible to improve the durability of the reaction frames 21 and 31, and to further improve the durability of the reaction force treatment mechanism 50.

As described above, the preferred embodiment of the invention has been described, but the invention is not limited to the above-described embodiment.

In the above-described embodiment, the stage apparatus 1 mounted with the reaction force treatment mechanism 50 is configured as a so-called stack-type XY stage, but may be configured as a surface-type XY stage. In addition, an X(Y) stage having only a mobile body moving only in one direction may be used, or an XZ(YZ) stage, an XZθ(YZθ) stage, an XYZ stage, an XYZθ stage, and an Xθ(Yθ) stage may be used.

In addition, the X-axis reaction force treatment mechanism 20 is disposed in each of both ends of the X-axis shaft portion 12x, but may be disposed in any only one of them. In addition, the stress relief mechanisms 24 and 34 may have a configuration in which a direction not absorbing the displacement exists. The configuration or arrangement of the stress relief mechanisms 24 and 34 is not limited to the above-described embodiment. For example, the stator (fixed block) does not need to be directly connected to the stress relief mechanism, but may be disposed at a position close to the pedestal or the center of the connection portion. Further, the connection portion itself may have an stress relief mechanism by the shape or material thereof.

Further, in the above-described embodiment, the shaft motors 11x and 11y are adopted as the actuator, but a magnet opposite type linear motor or the like may be adopted. In addition, the guide portion, the first and second guide portions, and the first and second support mechanism guide portions are not limited to the linear guide as in the above-described embodiment. For example, a plate spring or an elastic member which can displace only in one direction may be used.

When the reaction force treatment mechanism of the invention is used in the stage apparatus, the reaction force treatment mechanism exhibits an excellent performance. Particularly, the reaction force treatment mechanism can be suitably applied to an inspection apparatus, an examination apparatus, and the like.

1. A reaction force treatment mechanism used in a stage apparatus including a pedestal, a platen which is supported by the pedestal through a vibration isolation unit, a mobile body which is supported on the platen and moves on the platen, and an actuator which drives the mobile body in one direction, the reaction force treatment mechanism comprising:
a connection portion which connects a stator of the actuator to the pedestal through an stress relief mechanism for absorbing displacement in a direction different from the one direction; and
a guide portion which guides movement of the stator of the actuator relative to the platen in the one direction while restricting the movement in a direction different from the one direction.

2. A reaction force treatment mechanism used in a stage apparatus including a pedestal, a platen which is supported by the pedestal through a vibration isolation unit, first and second mobile bodies which are supported on the platen and move on the platen, a first actuator which drives the first mobile body in a first direction, and a second actuator which drives the second mobile body in a second direction intersecting the first direction, the reaction force treatment mechanism comprising:
a first connection portion which connects a stator of the first actuator to the pedestal through a first stress relief mechanism for absorbing displacement in a direction different from the first direction;
a second connection portion which connects a stator of the second actuator to the pedestal through a second stress relief mechanism for absorbing displacement in a direction different from the second direction;
a first guide portion which guides movement of the stator of the first actuator relative to the platen in the first direction while restricting the movement in a direction different from the first direction; and
a second guide portion which guides movement of the stator of the second actuator relative to the platen in the second direction while restricting the movement in a direction different from the second direction.

3. The reaction force treatment mechanism according to claim 2,
wherein the second mobile body is adapted to move on the first mobile body,
wherein the reaction force treatment mechanism further comprises a support mechanism which supports the stator of the second actuator, and
wherein the support mechanism is adapted to permit movement of the stator of the second actuator relative to the first mobile body in the second direction, and to permit synchronization movement between the stator and the first mobile body in the first direction.

4. The reaction force treatment mechanism according to claim 3,
wherein the support mechanism includes:
a base portion which is disposed on the platen;
a fixed block portion which is disposed on the base portion and is fixed to the stator of the second actuator;
a first support mechanism guide portion which guides movement of the fixed block portion relative to the base portion in the first direction while restricting the movement in the second direction; and
a second support mechanism guide portion which guides movement of the fixed block portion relative to the first mobile body in the second direction while restricting the movement in the first direction,
wherein the second connection portion connects the pedestal to the base portion through the second stress relief mechanism, and
wherein the second guide portion is provided between the platen and the base portion.

5. The reaction force treatment mechanism according to claim 1,
wherein the actuator is a shaft motor.

6. A reaction force treatment mechanism used in a stage apparatus including a pedestal, a platen which is supported by the pedestal through a vibration isolation unit, a mobile body which is supported on the platen and moves on the platen, and an actuator which drives the mobile body in one direction, the reaction force treatment mechanism comprising:
a connection portion which connects a stator of the actuator to the pedestal; and
a stator support portion which permits movement of the stator of the actuator relative to the platen in the one direction while restricting the movement in a direction different from the one direction,
wherein the stator support portion transfers a movement force of the stator of the actuator to the pedestal in the one direction, and transfers the movement force to the platen in a direction different from the one direction.

7. The reaction force treatment mechanism according to claim 6,
wherein the connection portion includes an stress relief mechanism which absorbs displacement in a direction different from the one direction so as to permit displacement generated between the pedestal and the stator of the actuator.

8. A stage apparatus comprising:
the reaction force treatment mechanism according to claim 2.

9. An inspection apparatus comprising:
the stage apparatus according to claim 7.
